(19) United States
(12) Patent Application Publication
(10) Pub. No.: US 2022/0388640 A1
(43) Pub. Date: Dec. 8, 2022

(54) TANDEM ELECTRIC ROTORCRAFT

(71) Applicant: Textron Innovations Inc., Providence, RI (US)

(72) Inventors: Steven Ray Ivans, Ponder, TX (US); Brent Chadwick Ross, Flower Mound, TX (US)

(73) Assignee: Bell Textron Inc., Fort Worth, TX (US)

(21) Appl. No.: 17/303,642

(22) Filed: Jun. 3, 2021

(51) Int. Cl. B64C 27/26; B64C 27/08; B64D 27/24

(52) U.S. Cl. CPC B64C 27/26; B64C 27/08; B64D 27/24

(57) ABSTRACT

An electric tandem rotorcraft is disclosed. The tandem rotorcraft can include a forward and an aft electric rotor assembly operably coupled to a fuselage of the rotor craft. The aft rotor assembly can be coupled to the fuselage via a tail structure. The rotorcraft can include a wing assembly that can be operably rotatable between a vertical lift configuration and a horizontal flight configuration. The wing assembly can be disposed between and/or below planes of rotation of the forward and aft rotor assemblies. The forward and aft rotor assemblies can have planes of rotation that overlap one another and may or may not intermesh. The forward and aft rotor assemblies can also be distanced such that their respective planes of rotation do not overlap.

### TECHNICAL FIELD

The present invention is generally related to rotorcraft, and specifically to tandem rotorcraft.

### BACKGROUND

Like traditional helicopters, tandem helicopters are utilized in situations in which vertical take-off and landing of the aircraft is desired. Traditional tandem helicopters are typically bulky and conventionally powered (e.g., with turboshaft engines), and their size can be disadvantageous in shipping, transport, and in finding adequate landing zones. Traditional tandem helicopters are generally large by necessity—they need to be sizeable enough to obtain efficiency while accommodating the extra complexity and weight of two rotors, transmissions, and driveshafts. The rotors and rotor blades themselves are extremely heavy and, while rotating, have immense inertia, meaning that varying a rotational speed of a rotor (such as to control movement of the aircraft during flight) can be a slow and inefficient process. As a result, almost all tandem helicopters include flapping rotors with full cyclic control, enabling the rotors to rotate at a substantially constant speed and utilize blade pitch angle control to accomplish three-dimensional movement. The size and weight of the rotor assemblies further lead to the positioning of the rotor assembles as close to a center of gravity of the aircraft as possible to maintain aircraft stability. Rotor assemblies are commonly positioned tightly against the fuselage and as close together as practicable.

Because of size considerations such as those discussed above, many tandem helicopters are designed such that the forward and aft rotors overlap one another. This configuration attempts to enhance efficiency by decreasing fuselage length (and thereby aircraft weight) and maximizing rotor swept area (and thereby generated lift). However, because of the need for flapping rotors, tilt of tandem helicopters during forward flight, and the need to keep the rotor assemblies low against the fuselage, overlapping the rotors generally requires that the forward and aft rotors also intermesh, leading to increased complexity, decreased rotor efficiency, and greater hazard. For example, the rotor assemblies typically have to be mechanically linked and geared to positively ensure successful intermeshing, as desynchronization would be catastrophic. A portion of each rotor's swept area will also be “contaminated” with “dirty” (e.g., turbulent) air generated by the other rotor at the point of overlap, which can negatively impact lift generated by one or both rotors.

Despite these challenges with intermeshing, it is impractical to attempt to disentangle forward and aft rotor assemblies from one another in traditional tandem helicopters. The sheer weight and complexity of a mechanical drive system of a given rotor assembly can provide additional barriers to distancing the rotor assemblies from each other, and attempting to support a rotor assembly with any component other than a fuselage is difficult, at best. Additionally, traditional tandem helicopters, while able to generate significant vertical lift, are nevertheless limited in their forward flight speeds compared to fixed wing alternatives or tiltrotors. Several factors play into this, including the sheer size of the aircraft and the aerodynamic discontinuities such as hub drag inherent in tandem helicopter designs (e.g., the Boeing CH-47 Chinook). This generally means that tandem rotor aircraft do not have desirable horizontal flight properties, thereby limiting their application.

### SUMMARY

The present disclosure describes the technical advantages of a tandem rotorcraft providing enhanced horizontal flight. In one embodiment, a tandem rotorcraft can include a wing assembly that can generate lift during forward flight. In another embodiment, a wing assembly can transition between a position substantially perpendicular with a longitudinal axis of a fuselage (vertical lift configuration) and a position substantially parallel with the longitudinal axis of the fuselage (horizontal flight configuration). For example, a wing assembly can rotate such that a lateral axis of the wing assembly can be substantially perpendicular with a longitudinal axis of a fuselage, such that the wing assembly's obstruction of a download generated by one or more rotor assemblies can be minimized and the vertical lift maximized during take-off and landing. In another example, the wing assembly can be rotated such that a lateral axis of the wing assembly can be substantially parallel with a longitudinal axis of a fuselage, such that the wing can provide lift to the aircraft while minimizing the strain on the rotors of the aircraft and offloading the rotor s so more of their thrust can be devoted to propulsion rather than lift. In another embodiment, the wing assembly can facilitate three-dimensional movement of the rotorcraft during flight, such as by rotating one or more sides of the wing assembly to generate the force (e.g., drag, lift, etc.) needed to help facilitate a specific maneuver.

In another embodiment, a winged tandem rotorcraft can include a wing assembly strategically coupled to a fuselage such that the wing assembly obstruction of rotor download is minimized as the wing can rotate in hover to reduce download. Additionally, the wing can take some cruise lift offload during flight mode to achieve higher speed.

For example, a wing assembly can be coupled substantially between and below a forward and an aft rotor assembly. In another example, wing assembly can be placed beneath an area of overlap of forward and aft rotor assemblies. In another embodiment, a wing assembly can be placed below and between planes of rotation of forward and aft rotor assemblies that do not overlap, such that when the wing assembly is in a vertical lift configuration, the wing assembly is substantially between both the forward and aft rotor assemblies.

In one embodiment, the rotor blades of the aft and forward rotor assemblies overlap, but may not intermesh. The aft and forward rotor assemblies can counter-rotate such that anti-torque rotors are unnecessary. In another embodiment, the aft rotor assembly can be distanced from a forward rotor assembly such that planes of rotation of the rotor assemblies do not overlap. Advantageously, the forward rotor assembly and the aft rotor assembly can be an electric rotor assembly having an electric motor. Tandem helicopters are traditionally large due to the complexity and weight of two rotors, transmissions, and a driveshaft. But with all electric rotor assemblies, there is no transmission or shafting. Instead of a fuel tank and driveshaft used in traditional aircraft, in one embodiment, the aircraft of the present disclosure includes an electric power train system including electric motors operably coupled to a battery. The electrically powered rotors can control the aircraft without flapping (e.g., cyclic), using differential RPM and blade pitch (e.g., collective) to control pitch, roll, and yaw.

In one embodiment, a tandem electric rotorcraft can include: a fuselage having a forward end and an aft end; a wing assembly operably coupled to the fuselage between the forward end and the aft end and operably rotatable between a vertical lift configuration and a horizontal flight configuration; a forward electric rotor assembly having forward rotor blades and operably coupled to forward end of the fuselage via a forward pylon, wherein the forward electric rotor assembly is configured to rotate in a first plane of rotation; and an aft electric rotor assembly having aft rotor blades and operably coupled to the aft end of the fuselage via an aft pylon, wherein the aft electric rotor assembly is configured to rotate in a second plane of rotation, wherein the first plane of rotation and the second plane of rotation overlap. The second plane of rotation can be disposed above the first plane of rotation. The vertical lift configuration can be a position substantially perpendicular with a longitudinal axis of the fuselage. The horizontal flight configuration can be a position substantially parallel with the longitudinal axis of the fuselage. Further comprising an actuator configured to transition the wing assembly between the vertical lift configuration and the horizontal flight configuration. The transition of the wing assembly can be pilot controlled. The transition of the wing assembly can be controlled via a flight control computer. The first plane of rotation and the second plane of rotation can intermesh. The wing assembly can be disposed below an area of overlap of the first plane of rotation and the second plane of rotation. Further comprising a tail structure disposed between the fuselage and the aft pylon.

In another embodiment, a non-overlapping tandem electric rotorcraft can include: a fuselage having a forward end and an aft end; a wing assembly operably coupled to the fuselage between the forward end and the aft end and operably rotatable between a vertical lift configuration and a horizontal flight configuration; a forward electric rotor assembly having forward rotor blades and operably coupled to forward end of the fuselage via a forward pylon, wherein the forward electric rotor assembly is configured to rotate in a first plane of rotation; and an aft electric rotor assembly having aft rotor blades and operably coupled to the aft end of the fuselage via an aft pylon, wherein the aft electric rotor assembly is configured to rotate in a second plane of rotation, wherein the first plane of rotation and the second plane of rotation overlap. The second plane of rotation can be disposed above the first plane of rotation. The first plane of rotation can be equiplanar with the second plane of rotation. Further comprising an actuator configured to transition the wing assembly between the vertical lift configuration and the horizontal flight configuration. The transition of the wing assembly can be pilot controlled. The transition of the wing assembly can be controlled via a flight control computer. The first plane of rotation and the second plane of rotation can intermesh. The wing assembly can be disposed below an area of overlap of the first plane of rotation and the second plane of rotation.

In another embodiment, a method of transitioning a flight configuration of a tandem electric rotorcraft, can include the steps of: rotating a wing assembly about a longitudinal wing axis such that a lateral wing axis is substantially perpendicular to a fuselage longitudinal axis; and rotating the wing assembly about the longitudinal wing axis such that the lateral wing axis is substantially parallel with the fuselage longitudinal axis, wherein the wing assembly is operably coupled to a fuselage of the tandem electric rotorcraft, and wherein the tandem electric rotorcraft includes a forward electric rotor assembly and an aft electric rotor assembly. Further comprising an actuator configured to transition the wing assembly between the vertical lift configuration and the horizontal flight configuration. The transition of the wing assembly can be pilot controlled. The transition of the wing assembly can be controlled via a flight control computer. The first plane of rotation and the second plane of rotation can intermesh. The wing assembly can be disposed below an area of overlap of the first plane of rotation and the second plane of rotation.

### BRIEF DESCRIPTION OF THE DRAWINGS

The present disclosure will be readily understood by the following detailed description, taken in conjunction with the accompanying drawings that illustrate, by way of example, the principles of the present disclosure. The drawings illustrate the design and utility of one or more exemplary embodiments of the present disclosure, in which like elements are referred to by like reference numbers or symbols. The objects and elements in the drawings are not necessarily drawn to scale, proportion, or precise positional relationship. Instead, emphasis is focused on illustrating the principles of the present disclosure.

FIGS. 1A-1C illustrate an exemplary overlapping tandem rotorcraft, in accordance with one or more exemplary embodiments of the present disclosure;

FIGS. 2A-2B illustrate an exemplary winged overlapping tandem rotorcraft, in accordance with one or more exemplary embodiments of the present disclosure;

FIGS. 3A-3C illustrate an exemplary tandem rotorcraft, in accordance with one or more exemplary embodiments of the present disclosure; and

FIG. 4A-4B illustrate an exemplary winged tandem rotorcraft, in accordance with one or more exemplary embodiments of the present disclosure.

### DETAILED DESCRIPTION

The preferred version of the disclosure presented in the following written description and the various features and advantageous details thereof, are explained more fully with reference to the non-limiting examples included in the accompanying drawings and as detailed in the description, which follows. Descriptions of well-known components have been omitted so to not unnecessarily obscure the principal features described herein. The examples used in the following description are intended to facilitate an understanding of the ways in which the disclosure can be implemented and practiced. Accordingly, these examples should not be construed as limiting the scope of the claims.

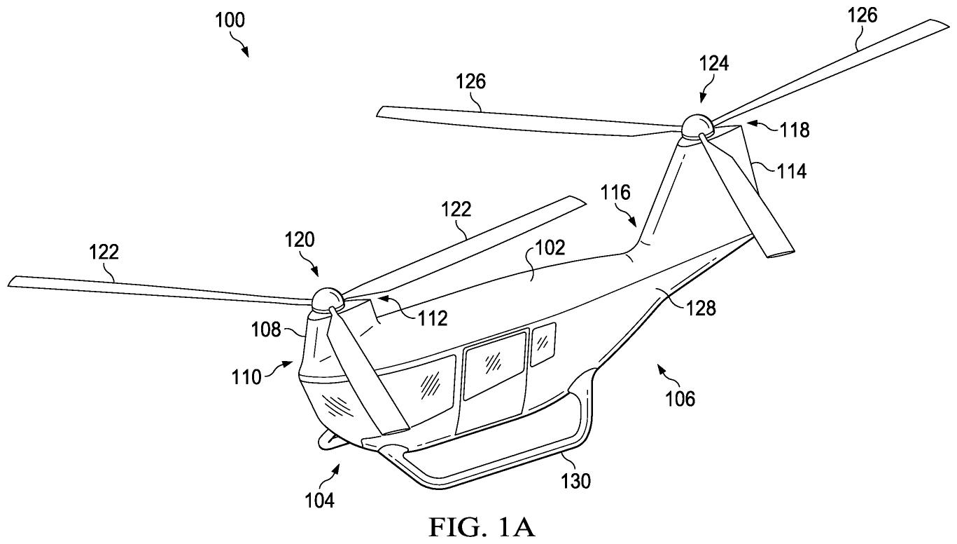

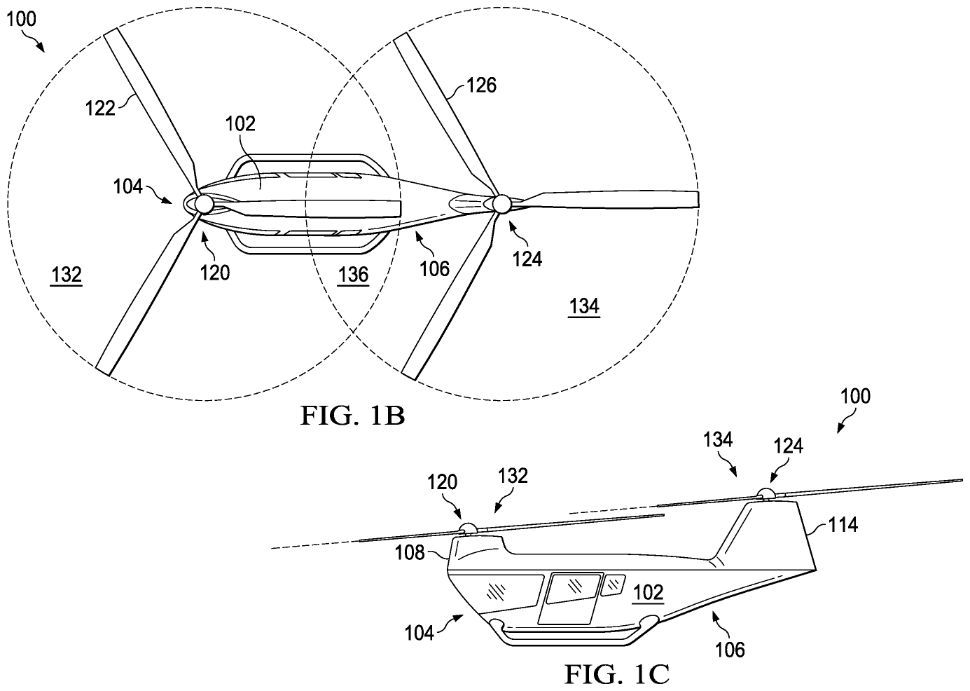

FIGS. 1A-1C depict perspective view of an overlapping tandem rotorcraft 100. In one embodiment, the rotorcraft 100 can include a fuselage 102. In one embodiment, the fuselage 102 can include a forward end 104 and an aft end 106. In one embodiment, the rotorcraft 100 can include a forward pylon 108. In another embodiment, the forward pylon 108 can include a first end 110 and a second end 112 and can be coupled proximate the forward end 104 of the fuselage 102 at the first end 110. In one example, a CG point can be disposed between the first end 110 and the second end 112. In another embodiment, the rotorcraft 100 can include an aft pylon 114, the aft pylon 114 can include a first end 116 and a second end 118. In another embodiment, the aft pylon 114 can be coupled to the fuselage 102 proximate the aft end 106 of the fuselage 102 at the first end 116 of the aft pylon 114. In one embodiment, a distance between the first end 116 and the second end 118 can define a second distance.

In another embodiment, the rotorcraft 100 can include a forward rotor assembly 120. In one embodiment, the forward rotor assembly 120 can be a forward electric rotor assembly 120. In another embodiment, the forward rotor assembly 120 can include forward rotor blades 122. In another embodiment, the rotorcraft 100 can include an aft rotor assembly 124. In one embodiment, the aft rotor assembly 124 can be an aft electric rotor assembly 124. In one embodiment, the aft rotor assembly 124 can include aft rotor blades 126. In another embodiment the forward rotor assembly 120 and the aft rotor assembly 124 may not be mechanically linked, such through a common turboshaft. In another embodiment, the rotorcraft 100 can include landing gear 130. The landing gear 130 can take the form of skids, floats, wheels, retractable wheels, or any other suitable component to facilitate the landing of the rotorcraft 100.

In another embodiment, the rotorcraft 100 can include a tail structure 128 disposed between the aft end 106 of the elongated member 102 and the aft pylon 114. For example, the tail structure 128 can be a tail boom. In another example, the tail structure 128 can be considered as part of the elongated member 102; in another embodiment, the tail structure 128 can be considered part of the aft end 106 of the elongated member 102. In another embodiment, the tail structure 128 can be considered a part of the aft pylon 114; in another embodiment, the tail structure 128 can be considered a part of the first end 116 of the aft pylon 114. In another embodiment, the tail structure 128 can be any component suitable to couple the aft pylon 114 to the elongated member 102. In another embodiment, the tail structure 128 can be any component suitable to support the aft rotor assembly 124.

In another embodiment, the forward rotor assembly 120 can be configured to rotate in a first plane of rotation 132. For example, the first plane of rotation 132 can be defined by a swept area of the forward rotor blades 122. In another embodiment, the first plane of rotation 132 can be any plane in which the forward rotor assembly 120 rotates. In another embodiment, the aft rotor assembly 124 can be configured to rotate in a second plane of rotation 134. For example, the second plane of rotation 134 can be defined by a swept area of the aft rotor blades 126. In another embodiment, the second plane of rotation 134 can be any plane in which the aft rotor assembly 124 rotates.

In another embodiment, the first plane of rotation 132 and the second plane of rotation 134 can be configured to overlap. In one embodiment, such overlap can define an area of overlap 136. In another embodiment, the second plane of rotation 134 can be disposed substantially above the first plane of rotation 132 (e.g., as seen in FIG. 1C). For example, the first distance (e.g., the distance between the elongated member 102 and the second end 112 of the forward pylon 108) can be shorter than the second distance (e.g., the distance between the elongated member 102 and the second end 118 of the aft pylon 114). In another example, the first plane of rotation 132 can be disposed substantially above the second plane of rotation. For example, the second distance (e.g., the distance between the elongated member 102 and the second end 118 of the aft pylon 114) can be shorter than the first distance (e.g., the distance between the elongated member 102 and the second end 112 of the forward pylon 108).

In one embodiment, the first and second planes of rotation 132, 134 can be static. In another embodiment, the first and second planes of rotation 132, 134 can be rigid. In another embodiment, the first and second planes of rotation 132, 134 can move. For example, the forward and/or aft rotor assemblies 120, 124 can include articulated (“flapping”) rotors, such that one or more of the rotor assemblies can adjust its respective plane of rotation. For example, as a rotor assembly “flaps,” articulates, or otherwise adjusts thrust, pitch, yaw, torque, or any other force and/or direction generated by the rotor, a plane of rotation can move and/or adjust, such as by tilting, expand in width (e.g., if one or more rotor blades are flapping up and down while the rotor assembly rotates), and/or deviating from an initial position and/or configuration in any other manner. For example, a plane of rotation can tilt around a central point of the rotor assembly.

In another embodiment, the first plane of rotation 132 and the second plane of rotation 134 can intermesh. In one embodiment, the first and second planes of rotation 132, 134 (and/or the forward and aft rotor assemblies 120, 124) can be considered to intermesh if the first and second planes of rotation 132, 134 overlap and are equiplanar (and/or parallel) with one another. In another embodiment, the first and second planes of rotation 132, 134 (and/or the forward and aft rotor assemblies 120, 124) can be considered to intermesh if the first and second planes of rotation 132, 134 overlap such that a movement of one rotor assembly could cause at least a portion of its rotor blade to enter into the plane of rotation of the rotor blade of the other rotor assembly. In another embodiment, the first and second planes of rotation 132, 134 can be considered to intermesh if the first or second plane of rotation 132, 134 is capable of intersecting and/or configured to intersect the other of the first or second plane of rotation 132, 134. In one embodiment, the rotorcraft and/or forward and aft rotor assemblies 120, 124 can be configured to facilitate intermeshing of the first and second planes of rotation 132, 134 without being mechanically linked, such as with the use of sensors, controllers, mechanical operators, or by any other suitable method or component. For example, a sensor can read the rotation angle of the forward and aft rotor assemblies to identify the location of the rotor blades. A controller can adjust the rotational speed of one or both of the rotor assemblies to synchronize them, such that the rotor blades for each rotor assembly will not contact the other. In another embodiment, the number of rotor blades of one or both of the forward and aft rotor assemblies 120, 124 can vary, such as to maximize intermesh clearance.

In another embodiment, the first and second planes of rotation 132, 134 can be configured to not intermesh. For example, one plane of rotation can be disposed sufficiently above another plane of rotation such that a movement of one or both of the planes of rotation would not cause the planes of rotation to intersect. For example, the first distance (e.g., the distance between the elongated member 102 and the second end 112 of the forward pylon 108) can be sufficiently shorter than the second distance (e.g., the distance between the elongated member 102 and the second end 118 of the aft pylon 114) such that movement of the first or second plane of rotation 132, 134 would not cause the first or second plane of rotation 132, 134 to intersect the other of the first or second plane of rotation 132, 134. In another example, the second distance (e.g., the distance between the elongated member 102 and the second end 118 of the aft pylon 114) can be sufficiently shorter than the first distance (e.g., the distance between the elongated member 102 and the second end 112 of the forward pylon 108) such that movement of the first or second plane of rotation 132, 134 would not cause the first or second plane of rotation 132, 134 to intersect the other of the first or second plane of rotation 132, 134. In another embodiment, one rotor assembly 120, 124 can be a sufficient distance above the other rotor assembly 120, 124 such that the rotors can maintain clearance from one another during flapping and/or feathering of either rotor.

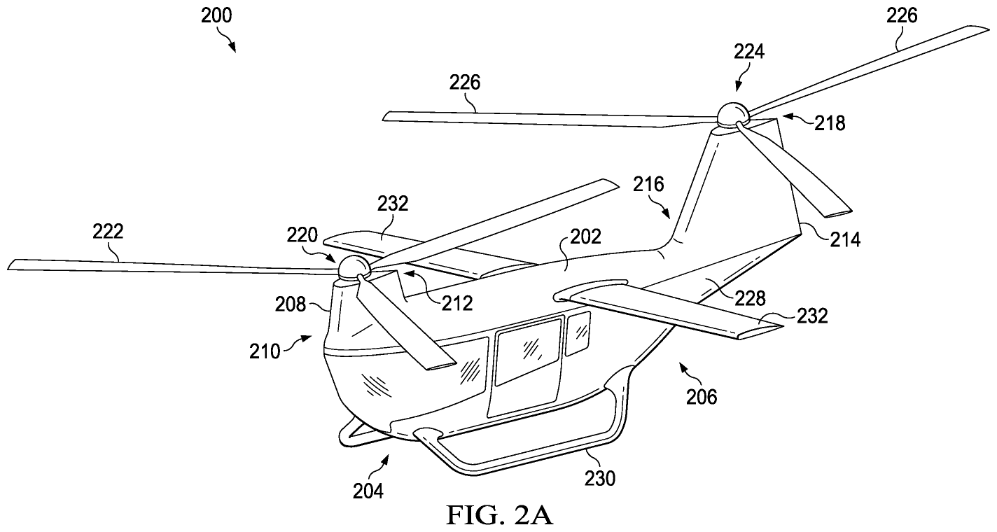

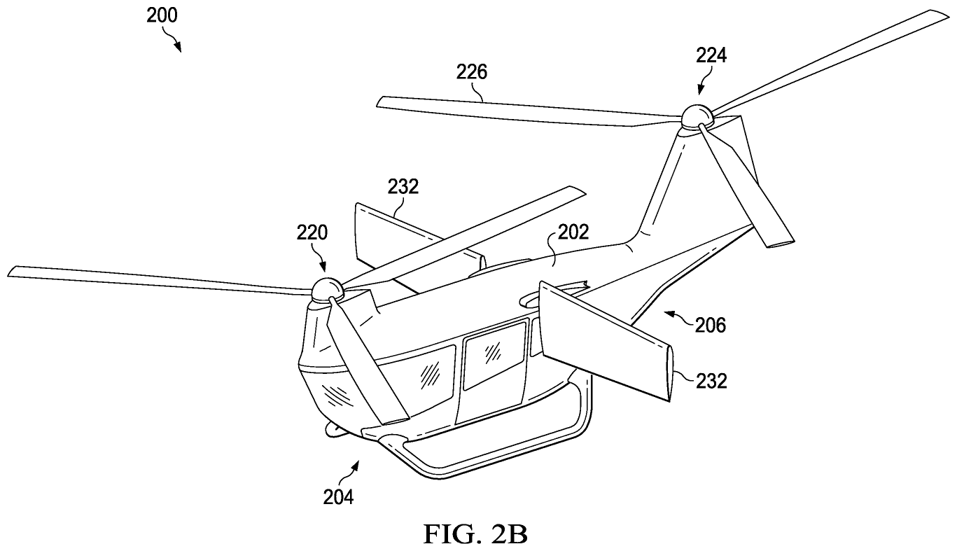

FIGS. 2A-2B depict another embodiment of the present disclosure. A winged overlapping tandem rotorcraft 200 can be similar to the overlapping tandem rotorcraft 100. In one embodiment, the winged overlapping tandem rotorcraft 200 can include the elements and components described with respect to the overlapping tandem rotorcraft 100 and can additionally include a wing assembly 232. In one embodiment, the rotorcraft 200 can include an elongated member 202. In one embodiment, the elongated member 202 can be a fuselage, nacelle, tail boom, or other suitable aircraft structure. In another embodiment, the fuselage 202 can include a forward end 204 and an aft end 206. In one embodiment, the rotorcraft 200 can include a forward pylon 208. In another embodiment, the forward pylon 208 can include a first end 210 and a second 212 and can be coupled proximate the forward end 204 of the fuselage 202 at the first end 210. In one example, the distance between the first end 210 and the second end 212 can define a first distance. In another embodiment, the rotorcraft 200 can include an aft pylon 214, and the aft pylon 214 can include a first end 216 and a second end 218. In another embodiment, the aft pylon 214 can be coupled to the fuselage 202 proximate the aft end 206 of the fuselage 202 at the first end 216 of the aft pylon 214. In one embodiment, a distance between the first end 216 and the second end 218 can define a second distance.

In another embodiment, the rotorcraft 200 can include a forward rotor assembly 220. In one embodiment, the forward rotor assembly 220 can be a forward electric rotor assembly 220. In another embodiment, the forward rotor assembly 220 can include forward rotor blades 222. In another embodiment, the rotorcraft 200 can include an aft rotor assembly 224. In one embodiment, the aft rotor assembly 224 can be an aft electric rotor assembly 224. In one embodiment, the aft rotor assembly 224 can include aft rotor blades 226. In another embodiment, the rotorcraft 200 can include landing gear 230. The landing gear 230 can take the form of skids, floats, wheels, retractable wheels, or any other suitable component to facilitate the landing of the rotorcraft 200.

In another embodiment, the rotorcraft 200 can include a tail structure 228 disposed between the aft end 206 of the elongated member 202 and the aft pylon 214. For example, the tail structure 228 can be a tail boom. In another embodiment, the aft rotor assembly 224 can be mounted on a tailboom or similar aircraft structure to extend it farther aft. A traditional mechanical tandem helicopter would be challenged to support the aft rotor on a tailboom because of the weight and complexity of the mechanical drive system, but with an electrically-powered rotor assembly, a tailboom can become practical.

In another example, the tail structure 228 can be considered as part of the elongated member 202. In another embodiment, the tail structure 228 can be considered part of the aft end 206 of the elongated member 202. In another embodiment, the tail structure 228 can be considered a part of the aft pylon 214. In another embodiment, the tail structure 228 can be considered a part of the first end 216 of the aft pylon 214. In another embodiment, the tail structure 228 can be any component suitable to couple the aft pylon 214 to the elongated member 202. In another embodiment, the tail structure 228 can be any component suitable to support the aft rotor assembly 224. In one embodiment, the forward and aft rotor assembly 220, 224 can be configured to rotate in a first plane of rotation and a second plane of rotation, respectively, in accordance with the principles of the present disclosure. In another embodiment, the planes of rotation of the rotor assembly 220, 224 can be configured to intermesh. In other embodiment, the planes of rotation of the rotor assemblies 220, 224 can be configured to not intermesh.

In another embodiment, the rotorcraft 200 can include a wing assembly 232. In one embodiment, the wing assembly 232 can be operably coupled to the elongated member 202 between the forward and aft ends 204. In another embodiment, the wing assembly 232 can include two wings, such as a port-side wing coupled to a port side of the elongated member 202, and a starboard-side wing coupled to the starboard side of the elongated member. In another embodiment, the wing assembly 232 can be a single wing, such as a single wing traversing a width of the elongated member 202. In one embodiment, the wing assembly 232 can be configured to facilitate lift, such as during horizontal flight, which, in one embodiment, can help enable the rotorcraft 200 to achieve higher speeds.

In another embodiment, the wing assembly 232 can be operably rotatable between a vertical lift configuration and a horizontal flight configuration. For example, the wing assembly 232 can be configured to rotate along a longitudinal axis of the wing assembly 232, such as until a lateral axis of the wing assembly 232 is substantially perpendicular with a longitudinal axis of the elongated member 202 (such as can be seen in, e.g., FIG. 2B). In another embodiment, the wing assembly 232 is substantially perpendicular when its lateral axis is within 10° of orthogonal to the longitudinal axis of the elongated member 202. In this manner, and as an example, the wing assembly 232 can be configured in a vertical lift configuration, such as by minimizing a profile of the wing assembly 232 as to a download generated by, e.g., the forward and/or aft rotor assemblies 220, 224. In another embodiment, the wing assembly 232 can also be rotated such that a lateral axis of the wing assembly 232 can be substantially parallel with a longitudinal axis of the elongated member 202 (such as can be seen in, e.g., FIG. 2A), such as to minimize a profile of the wing assembly 232 during forward flight and generate lift via air passage around the wing assembly 232. In another embodiment, the wing assembly 232 is substantially parallel when its lateral axis is within 10° of parallel to the longitudinal axis of the elongated member 202.

In another embodiment, the wing assembly 232 can be considered to be in a horizontal flight configuration if a forward edge of the wing assembly 232 is facing a direction substantially parallel with a forward end 204 of the elongated member 202. In another embodiment, the wing assembly 232 can be considered to be in a vertical lift configuration if a forward edge of the wing assembly 232 is facing substantially upwards, for example, towards a top surface of the elongated member, and/or towards the rotor assemblies 220, 224 and/or their respective planes of rotation. In another embodiment, the wing assembly 232 can rotate and/or maintain a position at 0°-360° around a longitudinal axis of the wing assembly 232. In another embodiment, the wing assembly 232 can be a “flying” wing. For example, the wing assembly 232 can be configured such that an attitude of the wing assembly 232 can be controlled to optimize aerodynamics, e.g. to help control the pitch of the aircraft and/or balance the trade-off between lift and rotor download through the entire flight spectrum from hover to forward flight. An angle of the wing assembly 232 can be pilot controlled or computer controlled.

In another embodiment, the wing assembly 232 can be strategically positioned on the rotorcraft 200. For example, the wing assembly 232 can be positioned on the elongated member 202 substantially mid-way between the forward and aft rotor assemblies 220, 224 and/or mid-way between the forward and aft ends 204, 206 of the elongated member 202. In one embodiment, the wing assembly 232 can be positioned below an area of overlap (e.g., an area of overlap similar to area of overlap 136) of planes of rotations of the rotor assembly 220, 224. In one embodiment, positioning the wing assembly 232 below an area of overlap can minimize obstruction by the wing assembly 232 of download generated by one or both of the forward and aft rotor assemblies 220, 224. In another embodiment, the wing assembly 232 can be coupled to the rotorcraft 200 in any manner suitable to minimize download obstruction by the wing assembly 232. In another embodiment, the wing assembly 200 can be coupled to the rotorcraft 200 in any manner suitable to facilitate lift generation by the wing assembly 200 during forward flight.

In one embodiment, overlap of forward and aft rotor assemblies in accordance with principles of the present disclosure can be advantageous, such as by reducing a size of the rotorcraft. For example, overlapping rotor assemblies can enable larger rotor assemblies on smaller crafts, such that a footprint and/or surface area of the rotorcraft can be smaller.

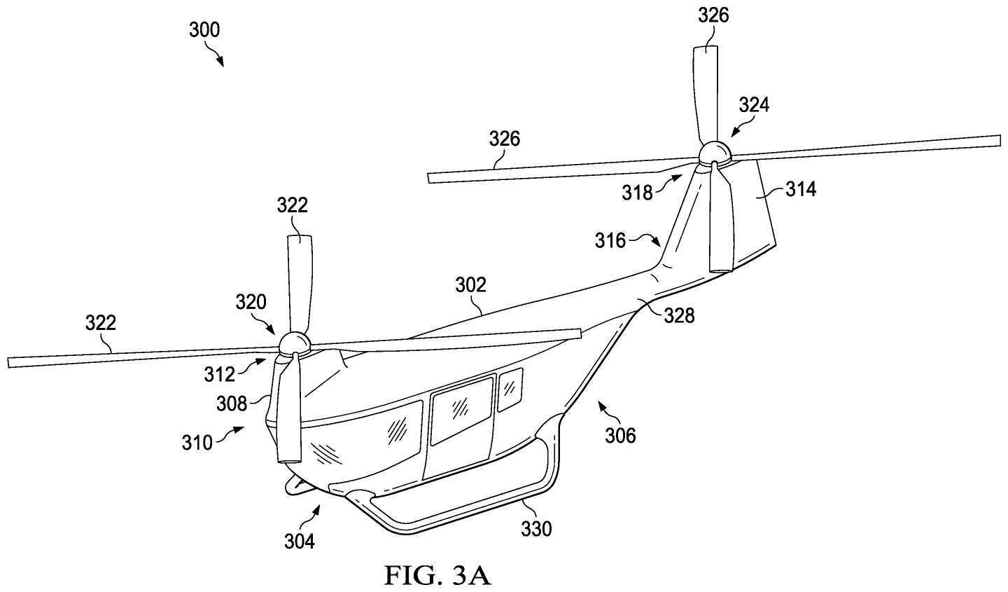

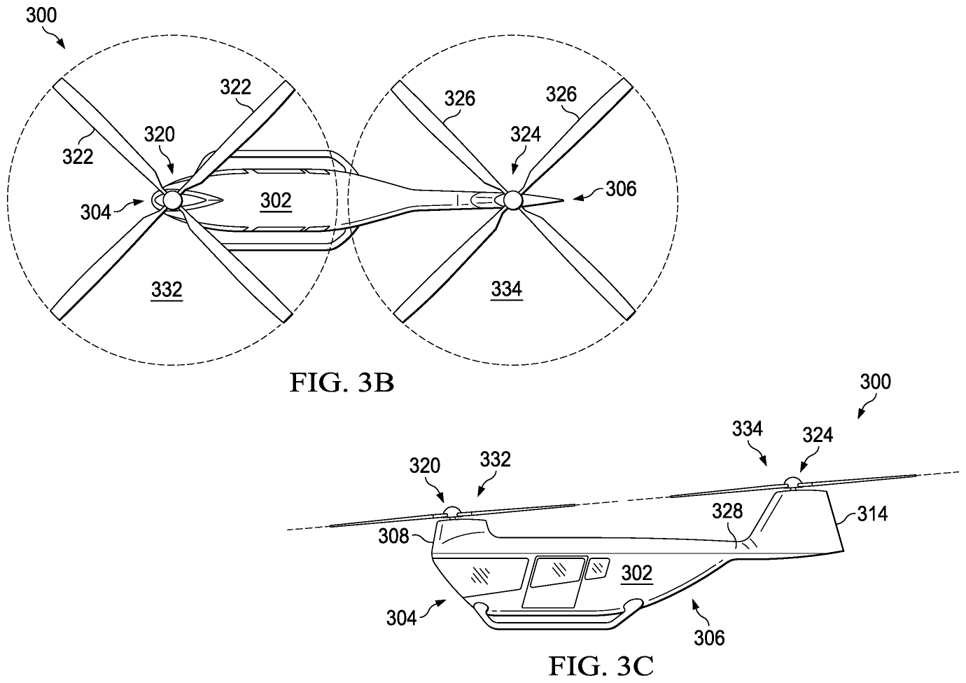

FIGS. 3A-3C depict perspective view of a tandem rotorcraft 300. In one embodiment, the rotorcraft 300 can include an elongated member 302. In one embodiment, the elongated member 302 can be a fuselage, nacelle, tail boom, or other suitable aircraft structure. In another embodiment, the fuselage 302 can include a forward end 304 and an aft end 306. In one embodiment, the rotorcraft 300 can include a forward pylon 308. In another embodiment, the forward pylon 308 can include a first end 310 and a second 312 and can be coupled proximate the forward end 304 of the fuselage 302 at the first end 310. In one example, the distance between the first end 310 and the second end 312 can define a first distance. In another embodiment, the rotorcraft 300 can include an aft pylon 314, and the aft pylon 314 can include a first end 316 and a second end 318. In another embodiment, the aft pylon 314 can be coupled to the fuselage 302 proximate the aft end 306 of the fuselage 302 at the first end 316 of the aft pylon 314. In one embodiment, a distance between the first end 316 and the second end 318 can define a second distance.

In another embodiment, the rotorcraft 300 can include a forward rotor assembly 320. In one embodiment, the forward rotor assembly 320 can be a forward electric rotor assembly 320. In another embodiment, the forward rotor assembly 320 can include forward rotor blades 322. In another embodiment, the rotorcraft 300 can include an aft rotor assembly 324. In one embodiment, the aft rotor assembly 324 can be an aft electric rotor assembly 324. In one embodiment, the aft rotor assembly 324 can include aft rotor blades 326. In another embodiment, the rotorcraft 300 can include landing gear 330. The landing gear 330 can take the form of skids, floats, wheels, retractable wheels, or any other suitable component to facilitate the landing of the rotorcraft 300.

In another embodiment, the rotorcraft 300 can include a tail structure 328 disposed between the aft end 306 of the elongated member 302 and the aft pylon 314. For example, the tail structure 328 can be a tail boom. In another example, the tail structure 328 can be considered as part of the elongated member 302. In another embodiment, the tail structure 328 can be considered part of the aft end 306 of the elongated member 302. In another embodiment, the tail structure 328 can be considered a part of the aft pylon 314. In another embodiment, the tail structure 328 can be considered a part of the first end 316 of the aft pylon 314. In another embodiment, the tail structure 328 can be any component suitable to couple the aft pylon 314 to the elongated member 302. In another embodiment, the tail structure 328 can be any component suitable to support the aft rotor assembly 324.

In another embodiment, the forward rotor assembly 320 can be configured to rotate in a first plane of rotation 332. For example, the first plane of rotation 332 can be defined by a swept area of the forward rotor blades 322. In another embodiment, the first plane of rotation 332 can be any plane in which the forward rotor assembly 320 rotates. In another embodiment, the aft rotor assembly 324 can be configured to rotate in a second plane of rotation 334. For example, the second plane of rotation 334 can be defined by a swept area of the aft rotor blades 326. In another embodiment, the second plane of rotation 334 can be any plane in which the aft rotor assembly 324 rotates.

In one embodiment, the rotorcraft 300 can be configured such that the first and second planes of rotation 332, 334 do not overlap. For example, the tail structure 328 can be configured to support the aft rotor assembly 324 and aft pylon 314 a sufficient distance from the forward rotor assembly 320 such that the second plane of rotation 334 does not overlap with the first plane of rotation 332. In one embodiment, the first and second planes of rotation 334, 336 can be equiplanar (such as can be seen in, e.g., FIG. 3C). In another embodiment, the forward rotor blades 322 and/or aft rotor blades 326 can be of a length that can prevent the planes of rotation of the forward and aft rotor assembly 320, 324 from overlapping. In another embodiment, the second plane of rotation 334 can be disposed substantially above the first plane of rotation 332. For example, the first distance (e.g., the distance between the elongated member 302 and the second end 312 of the forward pylon 308) can be shorter than the second distance (e.g., the distance between the elongated member 302 and the second end 318 of the aft pylon 314). In another example, the first plane of rotation 332 can be disposed substantially above the second plane of rotation. For example, the second distance (e.g., the distance between the elongated member 302 and the second end 318 of the aft pylon 314) can be shorter than the first distance (e.g., the distance between the elongated member 302 and the second end 312 of the forward pylon 308).

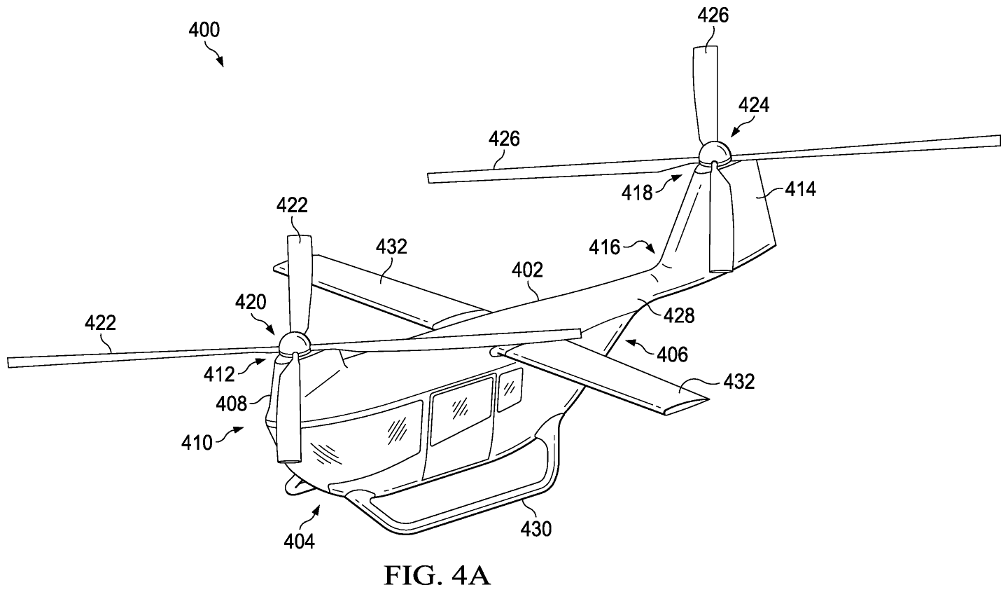

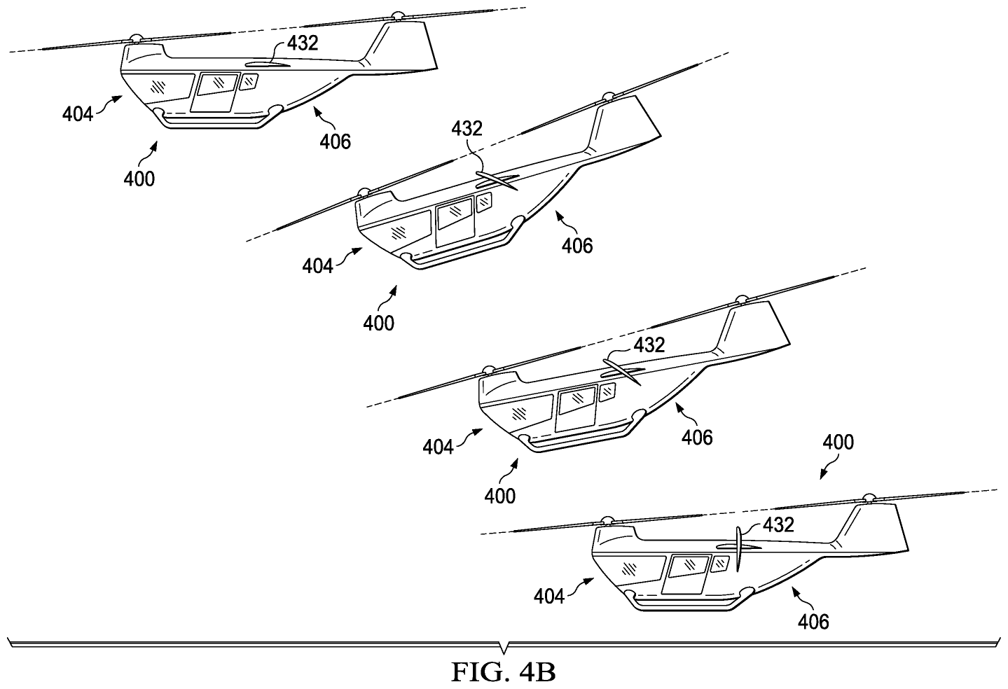

FIGS. 4A-4B depict another embodiment of the present disclosure. A winged tandem rotorcraft 400 can be similar to the tandem rotorcraft 300. In one embodiment, the winged tandem rotorcraft 400 can include the elements and components described with respect to the tandem rotorcraft 300 and can additionally include a wing assembly 432. In one embodiment, the rotorcraft 400 can include an elongated member 402. In one embodiment, the elongated member 402 can be a fuselage, nacelle, tail boom, or other suitable aircraft structure. In another embodiment, the fuselage 402 can include a forward end 404 and an aft end 406. In one embodiment, the rotorcraft 400 can include a forward pylon 408. In another embodiment, the forward pylon 408 can include a first end 410 and a second 412 and can be coupled proximate the forward end 404 of the fuselage 402 at the first end 410. In one example, the distance between the first end 410 and the second end 412 can define a first distance. In another embodiment, the rotorcraft 400 can include an aft pylon 414, and the aft pylon 414 can include a first end 416 and a second end 418. In another embodiment, the aft pylon 414 can be coupled to the fuselage 402 proximate the aft end 406 of the fuselage 402 at the first end 416 of the aft pylon 414. In one embodiment, a distance between the first end 416 and the second end 418 can define a second distance.

In another embodiment, the rotorcraft 400 can include a forward rotor assembly 420. In one embodiment, the forward rotor assembly 420 can be a forward electric rotor assembly 420. In another embodiment, the forward rotor assembly 420 can include forward rotor blades 422. In another embodiment, the rotorcraft 400 can include an aft rotor assembly 424. In one embodiment, the aft rotor assembly 424 can be an aft electric rotor assembly 424. In one embodiment, the aft rotor assembly 424 can include aft rotor blades 426. In another embodiment, the rotorcraft 400 can include landing gear 430. The landing gear 430 can take the form of skids, floats, wheels, retractable wheels, or any other suitable component to facilitate the landing of the rotorcraft 400.

In another embodiment, the rotorcraft 400 can include a tail structure 428 disposed between the aft end 406 of the elongated member 402 and the aft pylon 414. For example, the tail structure 428 can be a tail boom. In another example, the tail structure 428 can be considered as part of the elongated member 402. In another embodiment, the tail structure 428 can be considered part of the aft end 406 of the elongated member 402. In another embodiment, the tail structure 428 can be considered a part of the aft pylon 414. In another embodiment, the tail structure 428 can be considered a part of the first end 416 of the aft pylon 414. In another embodiment, the tail structure 428 can be any component suitable to couple the aft pylon 414 to the elongated member 402. In another embodiment, the tail structure 428 can be any component suitable to support the aft rotor assembly 424. In one embodiment, the forward and aft rotor assembly 420, 424 can be configured to rotate in a first plane of rotation and a second plane of rotation, respectively, in accordance with the principles of the present disclosure. In another embodiment, the planes of rotation of the rotor assembly 420, 424 can be configured to intermesh. In other embodiment, the planes of rotation of the rotor assemblies 420, 424 can be configured to not intermesh.

In another embodiment, the rotorcraft 400 can include a wing assembly 432. In one embodiment, the wing assembly 432 can be operably coupled to the elongated member 402 between the forward and aft ends 404. In another embodiment, the wing assembly 432 can include two wings, such as a port-side wing coupled to a port side of the elongated member 402, and a starboard-side wing coupled to the starboard side of the elongated member. In another embodiment, the wing assembly 432 can be a single wing, such as a single wing traversing a width of the elongated member 402. In one embodiment, the wing assembly 432 can be configured to facilitate lift, such as during horizontal flight, which, in one embodiment, can help enable the rotorcraft 400 to achieve higher speeds.

In another embodiment, the wing assembly 432 can be operably rotatable between a vertical lift configuration and a horizontal flight configuration. For example, the wing assembly 432 can be configured to rotate along a longitudinal axis of the wing assembly 432, such as until a lateral axis of the wing assembly 432 is substantially perpendicular with a longitudinal axis of the elongated member 402 (such as can be seen in, e.g., FIG. 4B). In this manner, and as an example, the wing assembly 432 can be configured in a vertical lift configuration, such as by minimizing a profile of the wing assembly 432 as to a download generated by, for example, the forward and/or aft rotor assemblies 420, 424. In another embodiment, the wing assembly 432 can also be rotated such that a lateral axis of the wing assembly 432 can be substantially parallel with a longitudinal axis of the elongated member 402 (such as can be seen in, e.g., FIG. 4A), such as to minimize a profile of the wing assembly 432 during forward flight and generate lift via air passage around the wing assembly 432.

In another embodiment, the wing assembly 432 can be considered to be in a horizontal flight configuration if a forward edge of the wing assembly 432 is facing a direction substantially parallel with a forward end 404 of the elongated member 402. In another embodiment, the wing assembly 432 can be considered to be in a vertical lift configuration if a forward edge of the wing assembly 432 is facing substantially upwards, e.g., towards a top surface of the elongated member, and/or towards the rotor assemblies 420, 424 and/or their respective planes of rotation. In another embodiment, the wing assembly 432 can rotate and/or maintain a position at 0°-360° around a longitudinal axis of the wing assembly 432. For example, an actuator can transition the wing assembly 432 between a position substantially perpendicular with a longitudinal axis of a fuselage (vertical lift configuration) and a position substantially parallel with the longitudinal axis of the fuselage (horizontal flight configuration). In another embodiment, the angle of the wing assembly 432 can be pilot controlled (e.g., via one or more controls disposed within the fuselage) or computer controlled (e.g., via a flight control computer). In another embodiment, the wing assembly 432 can be a “flying” wing. For example, the wing assembly 432 can be configured such that an attitude of the wing assembly 432 can be controlled to optimize aerodynamics to help control the pitch of the aircraft and/or balance the trade-off between lift and rotor download through the entire flight spectrum from hover to forward flight. The flight control computer algorithm can determine an optimized position of the wing assembly 432 by weighting factors such as the aircraft's speed, altitude, weight, or other relevant factors to transition the wing assembly 432 between positions. In another example, the actuator may maintain the wing assembly 432 in one or more positions between the vertical lift configuration and the horizontal flight configuration for a period of time. Some exemplary configurations of the wing assembly 432 can be seen in, e.g., FIG. 4B.

In another embodiment, the wing assembly 432 can be strategically positioned on the rotorcraft 400. For example, the wing assembly 432 can be positioned on the elongated member 402 substantially mid-way between the forward and aft rotor assemblies 420, 424 and/or mid-way between the forward and aft ends 404, 406 of the elongated member 402. In one embodiment, the wing assembly 432 can be positioned below and between the first and second planes of rotation of the forward and aft rotor assemblies 420, 424. In one embodiment, positioning the wing assembly 432 below and between the planes of rotation of the forward and aft rotor assemblies 420, 424 can minimize obstruction by the wing assembly 432 of download generated by one or both of the forward and aft rotor assemblies 420, 424. In another embodiment, the wing assembly 432 can be of a width such that when the wing assembly 432 is in a vertical lift configuration (e.g., a lateral axis of the wing assembly 432 is substantially perpendicular to a longitudinal axis of the elongated member 402), the wing assembly 432 can extend upwards to be disposed substantially between the planes of rotation of the forward and aft rotor assembly 420, 424. In another embodiment, the wing assembly 432 can be coupled to the rotorcraft 400 in any manner suitable to minimize download obstruction by the wing assembly 432. In another embodiment, the wing assembly 432 can be coupled to the rotorcraft 400 in any manner suitable to facilitate lift generation by the wing assembly 432 during forward flight. In another embodiment, the wing assembly 432 can be coupled to the elongated member 402 in a position as close to the C.G. as possible.

The wing assembles in accordance with the principles of the present disclosure can also be utilized, in one embodiment, to affect control of three-dimensional movement of the aircraft to which it is operably coupled. For example (and as seen in, e.g., FIG. 4B), a port side and a starboard side of a wing assembly can be individually controlled, such that one side of the wing assembly can rotate to facilitate a particular movement. In another embodiment, a wing assembly can include two wings, and each wing can be configured to rotate along its longitudinal axis independently of the other wing. For example, one wing can be rotated to increase lift, resistance, etc. to effectuate a particular maneuver. In another embodiment, aircrafts in accordance with the principles of the present disclosure can include, for example, an empennage. In one embodiment, a rudder can be coupled proximate an aft pylon (e.g., aft pylon 114, 214, 314, 414), such as to facilitate increased aerodynamic control of the aircraft in, e.g., forward flight.

In one embodiment, avoiding overlap of, e.g., forward and aft rotor assemblies in accordance with the principles of the present disclosure can be advantageous, such as by maximizing efficiency of each of the rotor assemblies by maintaining an area of clean (e.g. non-disturbed) air in which the rotor assembly can generate thrust and/or lift. In another embodiment, avoiding overlap of rotor assemblies can obviate any need to account for rotor assembly intermeshing, potentially enabling further degrees of movement for each rotor assembly (e.g., increased flapping, differential control, etc.). Additional rotor blades can also be incorporated into the rotor assemblies, such as to increase lift and/or thrust generated by the rotor assemblies. In another embodiment, avoiding intermeshing can also be advantageous in that it can eliminate the challenge of synchronizing rotors. In another embodiment, avoiding intermeshing can further enable inclusion of, e.g., than three rotor blades on each rotor assembly. In another embodiment, the present disclosure can enable aft rotor assemblies like those disclosed herein to be mounted on a tail structure (e.g., a tail boom or other suitable structure) to enable the positioning of the aft rotor assembly farther aft. For example, an aft electric rotor assembly can be lighter and/or less complex than traditional tandem rotorcraft rotor assemblies, enabling coupling of the aft electric rotor assembly to the elongated member via a tail structure.

In another embodiment, aircrafts in accordance with the principles of the present disclosure can minimize rotor assembly complexity by utilizing rotor rotational speed control to affect three-dimensional movement. For example, the rotor assemblies disclosed herein can include electrically powered rotor assemblies that can utilize lighter rotors such that RPM cycling and/or control can be accomplished, such as to control the flight of the aircraft. In another embodiment, the aircrafts disclosed herein can be configured such that control of the aircraft in flight can be accomplished without flapping (e.g., the cyclic). In another embodiment, the electric rotor assemblies discussed herein can utilize differential RPM and blade pitch (e.g., collective) to control pitch, roll, and yaw.

In one embodiment, aircrafts designed in accordance with the principles of the present disclosure can enable storage of an aircraft within a container. For example, the rotor assemblies disclosed herein (and/or blades thereof) can be capable of folding, such as minimize a profile and/or radius of the rotor assemblies. In another example, aircrafts with wing assemblies can include lighter and/or less cumbersome wing assemblies. In another embodiment, the wing assemblies disclosed herein can be capable of folding. In one embodiment, the wing assemblies can be capable of rotating. In one embodiment, the wing assemblies 232, 432 can be capable of folding, such as to position a longitudinal axis of the wing assembly to be substantially parallel with a longitudinal axis of an elongated member. In another embodiment, wing assemblies can be capable of rotating about a central point of the wing assembly such that wing tips of the wing assembly can be substantially aligned with a longitudinal axis of an elongated member. In another embodiment, the aircraft disclosed herein can be capable of fitting in an intermodal container. In another embodiment, the aircraft disclosed herein can be capable of fitting inside an ISO container. In another embodiment, the aircraft disclosed herein can be capable of fitting in a container with dimensions of 20 feet×8 feet×8 feet. In another embodiment, the aircraft disclosed herein can be capable of fitting into any suitable container. In another embodiment, a folding and/or rotation of the wing assembly of the aircraft can facilitate storage of the aircraft in any suitable container.

In another embodiment, any of the aircrafts disclosed herein can incorporate any number of designs or aspects operable to enhance a stealth profile of the aircraft. For example, the aircrafts can include one or more chines that can be configured to reduce a signature of the aircraft, such as a radar signature. Further, the rotor assemblies discussed herein are not limited to any specific design. The embodiments disclose any type of rotor assembly used or potentially used in the propulsion of aircraft. In one embodiment, the rotors assemblies can be propeller type rotors, each assembly comprising a plurality of propeller blades. In one embodiment, the rotor assemblies discussed herein can be electric; in another embodiment, the rotor assemblies discussed herein can utilize gas, diesel, or any other suitable fuel and/or energy source.

In one embodiment, the aircrafts disclosed herein can include one or more batteries, such as to provide power to one or more electric rotor assemblies of the aircraft. For example, the aircraft can include a battery in the floor of an elongated member; in another embodiment, a battery can be included behind a seat in an elongated member. In another embodiment, the rotor assemblies discussed herein can be in series, such as to facilitate intermeshing of the rotor assemblies, and/or to facilitate redundancy of operation of reach rotor assembly. In another embodiment, each of the rotor assemblies can stand alone, such that one rotor assembly can operate independently of another rotor assembly. In another embodiment, each rotor assembly can include a motor. In another embodiment, aircrafts disclosed herein can include additional motors. For example, each rotor assembly can include a motor, and each rotor assembly can further be operably coupled to a third motor of the aircraft, such that, for example, if one or more of the engines of the rotor assemblies fail, the rotor assemblies can be powered by the third motor. In another embodiment, each rotor assembly can be linked to a motor of the other rotor assembly, such that if one rotor assembly motor fails, the other rotor assembly motor can power both rotor assemblies.

In another embodiment, the rotor assemblies discussed herein can be configured to autorotate, such as in the event of a failure of a power source configured to power a rotor assembly. In another embodiment, rotor assemblies discussed herein can have planes of rotation substantially parallel with a longitudinal axis of an elongated member. In another embodiment, the rotor assemblies discussed herein can be canted. In another embodiment, the rotor assemblies discussed herein can be configured to rotate opposite directions of one another, such as to counteract a torque effect that each rotor can apply to the aircraft. In another embodiment, aircrafts in accordance with the principles of the present disclosure can weigh 50,000 pounds, have a useful load of 24,000 pounds, and/or have a rotor diameter of 60 feet. In another embodiment, aircrafts in accordance with the principles of the present disclosure can be smaller than this; in another embodiment, aircrafts in accordance with the principles of the present disclosure can be larger than this.

In another embodiment, electric rotor assemblies in accordance with the principles of the present disclosure can provide advantages over traditional tandem rotorcrafts known in the art. In one embodiment, the present disclosure can obtain efficiency with a decreased aircraft size by utilizing electric rotor assemblies, which obviates transmission and shafting that is required in traditional tandem rotorcrafts. For example, and in one embodiment, the present disclosure can utilize electrical power with rotor assemblies to achieve smaller crafts. In another embodiment, an advantage of tandem craft disclosed herein is that two rotors, rotating in opposite directions, can balance torque and abrogate a need for an anti-torque device (e.g., tail rotor). In another embodiment, tandem rotors like those disclosed herein can create more longitudinal control and C.G. range.

The present invention achieves at least the following advantages:

1. Enables vertical takeoff and landing capabilities while facilitating a horizontal flight configuration that decreases download obstruction and provides for increased lift generation in forward flight;

2. Improves center of gravity (CG) envelope in rotorcraft by placing rotor assemblies in tandem;

3. Enables the placement of an aft rotor assembly farther aft such that forward/aft rotor overlapping and/or intermeshing can be avoided;

4. Provides a wing assembly capable for assuming a vertical takeoff configuration and a horizontal flight configuration;

5. Increased pitch control by placing rotor assembles along a longitudinal axis of the aircraft;

6. Decreases aircraft footprint by simplifying and making lighter rotor assemblies on a tandem aircraft;

4. Increases storability by incorporating folding or rotating wing assembly and/or rotor assembly;

6. Increases vertical lift and horizontal lift by incorporating rotatable wing assembly; and

7. Tandem rotorcraft with electric rotor assemblies.

While the disclosure has described a number of embodiments, it is not thus limited and is susceptible to various changes and modifications without departing from the spirit thereof. Persons skilled in the art will understand that this concept is susceptible to various changes and modifications and may be implemented or adapted readily to other types of environments. For example, different rotor diameters for the forward and aft rotor assemblies, orthogonal rotor assemblies, full cyclic or only lateral, and variable RPM vs. collective at small scale are all within the scope of the present disclosure. Further, the individual elements of the claims are not well-understood, routine, or conventional. Instead, the claims are directed to the unconventional inventive concept described in the specification.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f).

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the inventions can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A tandem electric rotorcraft, comprising:
a fuselage having a forward end and an aft end;
a wing assembly operably coupled to the fuselage between the forward end and the aft end and operably rotatable between a vertical lift configuration and a horizontal flight configuration;
a forward electric rotor assembly having forward rotor blades and operably coupled to forward end of the fuselage via a forward pylon, wherein the forward electric rotor assembly is configured to rotate in a first plane of rotation; and
an aft electric rotor assembly having aft rotor blades and operably coupled to the aft end of the fuselage via an aft pylon, wherein the aft electric rotor assembly is configured to rotate in a second plane of rotation,
wherein the first plane of rotation and the second plane of rotation overlap.

2. The tandem electric rotorcraft of claim 1, wherein the second plane of rotation is disposed above the first plane of rotation.

3. The tandem electric rotorcraft of claim 1, wherein the vertical lift configuration is a position substantially perpendicular with a longitudinal axis of the fuselage.

4. The tandem electric rotorcraft of claim 1, wherein the horizontal flight configuration is a position substantially parallel with the longitudinal axis of the fuselage.

5. The tandem electric rotorcraft of claim 1, further comprising an actuator configured to transition the wing assembly between the vertical lift configuration and the horizontal flight configuration.

6. The tandem electric rotorcraft of claim 5, wherein the transition of the wing assembly is pilot controlled.

7. The tandem electric rotorcraft of claim 5, wherein the transition of the wing assembly is controlled via a flight control computer.

8. The tandem electric rotorcraft of claim 1, wherein the first plane of rotation and the second plane of rotation intermesh.

9. The tandem electric rotorcraft of claim 1, wherein the wing assembly is disposed below an area of overlap of the first plane of rotation and the second plane of rotation.

10. The tandem electric rotorcraft of claim 1, further comprising a tail structure disposed between the fuselage and the aft pylon.

11. A non-overlapping tandem electric rotorcraft, comprising:
a fuselage having a forward end and an aft end;
a wing assembly operably coupled to the fuselage between the forward end and the aft end and operably rotatable between a vertical lift configuration and a horizontal flight configuration;
a forward electric rotor assembly having forward rotor blades and operably coupled to forward end of the fuselage via a forward pylon, wherein the forward electric rotor assembly is configured to rotate in a first plane of rotation; and
an aft electric rotor assembly having aft rotor blades and operably coupled to the aft end of the fuselage via an aft pylon, wherein the aft electric rotor assembly is configured to rotate in a second plane of rotation,
wherein the first plane of rotation and the second plane of rotation overlap.

12. The non-overlapping tandem electric rotorcraft of claim 11, wherein the second plane of rotation is disposed above the first plane of rotation.

13. The non-overlapping tandem electric rotorcraft of claim 11, wherein the first plane of rotation is equiplanar with the second plane of rotation.

14. The non-overlapping tandem electric rotorcraft of claim 11, further comprising an actuator configured to transition the wing assembly between the vertical lift configuration and the horizontal flight configuration.

15. The non-overlapping tandem electric rotorcraft of claim 14, wherein the transition of the wing assembly is pilot controlled.

16. The non-overlapping tandem electric rotorcraft of claim 14, wherein the transition of the wing assembly is controlled via a flight control computer.

17. The non-overlapping tandem electric rotorcraft of claim 11, wherein the first plane of rotation and the second plane of rotation intermesh.

18. The non-overlapping tandem electric rotorcraft of claim 11, wherein the wing assembly is disposed below an area of overlap of the first plane of rotation and the second plane of rotation.

19. A method of transitioning a flight configuration of a tandem electric rotorcraft, the method comprising the steps of:
rotating a wing assembly about a longitudinal wing axis such that a lateral wing axis is substantially perpendicular to a fuselage longitudinal axis; and
rotating the wing assembly about the longitudinal wing axis such that the lateral wing axis is substantially parallel with the fuselage longitudinal axis,
wherein the wing assembly is operably coupled to a fuselage of the tandem electric rotorcraft, and
wherein the tandem electric rotorcraft includes a forward electric rotor assembly and an aft electric rotor assembly.

20. The electric tandem non-overlapping rotorcraft of claim 19, further comprising an actuator configured to transition the wing assembly between the vertical lift configuration and the horizontal flight configuration.

21. The electric tandem non-overlapping rotorcraft of claim 20, wherein the transition of the wing assembly is pilot controlled.

22. The electric tandem non-overlapping rotorcraft of claim 20, wherein the transition of the wing assembly is controlled via a flight control computer.

23. The electric tandem non-overlapping rotorcraft of claim 19, wherein the first plane of rotation and the second plane of rotation intermesh.

24. The electric tandem non-overlapping rotorcraft of claim 19, wherein the wing assembly is disposed below an area of overlap of the first plane of rotation and the second plane of rotation.
